(19) United States
(12) Patent Application Publication
(10) Pub. No.: US 2014/0089135 A1
(43) Pub. Date: Mar. 27, 2014

(54) SYSTEM AND METHOD FOR ENABLING A REAL TIME SHARED SHOPPING EXPERIENCE

(71) Applicant: BONFIRE HOLDINGS, INC., Marina Del Rey, CA (US)

(72) Inventors: Dzuy LINH, Marina Del Rey, CA (US); Alexander VOLTZ, Marina Del Rey, CA (US)

(73) Assignee: BONFIRE HOLDINGS, INC., Marina Del Rey, CA (US)

(21) Appl. No.: 13/629,228

(22) Filed: Sep. 27, 2012

(51) Int. Cl. G06Q 30/00

(52) U.S. Cl. 705/26.7

(57) ABSTRACT

Embodiments of the invention comprise a system, computer program product, and computer-implemented method for performing a process of creating the list of products that a user can purchase and a process of allowing the user to share a product from the list of products with a second user in real time. In some embodiments, the computer program product implements the steps of prompting the user for a selection of user tags from a list of user tags and a social media profile page associated with the user. For example, the user tags may include a user gender, a product type, a product manufacturer, and a product retailer. Responsive to the receipt of the user tags, embodiments of the invention create the list of products matching the user tags and display at least one product from the list of product on a mobile device associated with the user.

### CROSS-REFERENCE TO RELATED APPLICATION

This application is related to co-pending U.S. patent application Ser. No. 13/629,136, titled “System and Method for Creating a Customized Shopping Experience for a User”, by Linh, et al., Attorney Docket No. 2207682-121US1, filed on the same day, Sep. 27, 2012, which is herein incorporated in its entirety by reference.

### FIELD OF INVENTION

The following invention relates generally to online shopping, and more particularly to a system, computer program product and computer-implemented method for using a mobile device to display a user specific list of possible products to purchase and to share the products in real time with another user to create a shared shopping experience.

### BACKGROUND OF THE INVENTION

Traditionally, to purchase an item from a merchant website, a user would have to perform an internal search for the particular item, select the item and complete the transaction. Such sites were more efficient for the user than visiting a brick and mortar store, but had the drawback that it took a significant amount of time to sort through items. Moreover, if a user wanted the opinion of friends and family before making a purchase, webpage links to products had to be emailed for comment. For purchases involving vintage, used, collectable or limited quantity items, the delay between sending an email message and the response from friends and family often resulted in the product being sold before the user could complete the transaction. To solve these problems, merchants added additional features to their webpages that, for example, enabled a user to email the item to a friend (or like, pin, “thumbs up”, etc.) from the seller webpage and/or to sort the items by type, size or price, or to narrow the field of search by product category. While these features made the webpages more navigable for the user, the user still had to search through the filtered items to find a product. And, because the initial webpage was not tailored to the user, when the user used a filter mechanism, the merchant missed out on enticing the user to purchase suggested products (e.g., items the user might like based upon the user's preferences). Moreover, these added features did not reduce the delay between the user emailing the item to a recipient and the recipient commenting on same.

To solve some of the sorting problems, some merchants have recently been aggregating products on their sites to match a user's preferences, and send daily emails to users indicating which products match the user's preferences. Merchants can identify a user's preferences by using web search analytics (i.e., the types of sites and pages a user is visiting or the types of purchases the user is making). Unfortunately, the user's web browser may block such analytic engines. Another strategy that has been employed by merchants, is tailoring product listing to each user in a daily email message. Such email messages are created in response to the user completing a lengthy survey, and with each message, the user is asked to respond to whether they liked a particular product to tailor further future messages. Because this survey and feedback mechanism is time consuming and the use of email requires the user to open two programs—the user's email service and the user's web browser. However, merchants applying these techniques have not experienced widespread adoption of these features.

A need exists, therefore, for a system, method and computer program product that solves the issues identified above.

### SUMMARY OF INVENTION

Embodiments of the invention comprise a computer for making products available for a user to purchase. In some embodiments, the computer comprises a tangible non-transitory computer memory, the computer memory having stored thereon a plurality of computer instructions performing a process of creating a list of products that the user can purchase and a process of allowing the user to share a product from the list of products with a second user in real time. The instructions may include the steps of creating the list of products using user tags, the user tags corresponding to user product preferences; formatting a display page to display at least one product from the list of products on a mobile device associated with the user, the display page prompting the user to select a second user to share the display page with; transmitting the display page to a second mobile device associated with the second user; responsive to the transmission of the display page to the second user, formatting the display page to display the at least one product from the list of products on the second mobile device and allowing the user and second user to post comments regarding the product; and allowing the user to control the display page on a second user mobile device to thereby enable the user and the second user to view substantially the same product on the display page.

Other embodiments of the invention comprise a computer program product comprised of a series of instructions executable on a computer, the computer program product performing a process of creating a list of products that the user can purchase and a process of allowing the user to share a product from the list of products with a second user in real time. The instructions may include the steps of creating the list of products using user tags, the user tags corresponding to user product preferences; formatting a display page to display at least one product from the list of products on a mobile device associated with the user, the display page prompting the user to select a second user to share the display page with; transmitting the display page to a second mobile device associated with the second user; responsive to the transmission of the display page to the second user, formatting the display page to display the at least one product from the list of products on the second mobile device and allowing the user and second user to post comments regarding the product; and allowing the user to control the display page on a second user mobile device to thereby enable the user and the second user to view substantially the same product on the display page.

And, other embodiments of the invention comprise a computer-implemented method comprised of a series of instructions that cause a computer to perform a process of creating a list of products that the user can purchase and a process of allowing the user to share a product from the list of products with a second user in real time. The instructions may include the steps of creating the list of products using user tags, the user tags corresponding to user product preferences; formatting a display page to display at least one product from the list of products on a mobile device associated with the user, the display page prompting the user to select a second user to share the display page with; transmitting the display page to a second mobile device associated with the second user; responsive to the transmission of the display page to the second user, formatting the display page to display the at least one product from the list of products on the second mobile device and allowing the user and second user to post comments regarding the product; and allowing the user to control the display page on a second user mobile device to thereby enable the user and the second user to view substantially the same product on the display page.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is a network diagram of a merchant system including a user device, a communications network and a merchant server according to an embodiment of the invention;

FIG. 2 is an electronic block diagram of a merchant server for providing access to the system according to an embodiment of the invention;

FIG. 3 is a software block diagram of a merchant server having a program product in memory thereon including several operation modules according to an embodiment of the invention;

FIG. 4A is a software flow diagram for obtaining user account information and preferences according to an embodiment of the invention;

FIG. 4B is a software flow diagram for obtaining consumer preference data from various third party social media sites according to an embodiment of the invention;

FIG. 4C is a software flow diagram for providing product suggestions for consumer preferences according to an embodiment of the invention;

FIG. 4D is a software flow diagram for product sharing between a first user and a second user in real time according to an embodiment of the invention;

FIG. 4E is a software flow diagram for processing payment from the first or second user according to an embodiment of the invention;

FIG. 4F is a software flow diagram for connecting user comments to third party social media sites according to an embodiment of the invention;

FIG. 4G is a software flow diagram for uploading seller product to a merchant server and database according to an embodiment of the invention;

FIG. 5A is an electronic block diagram of a mobile device for use with the system according to an embodiment of the invention;

FIG. 5B is a software block diagram of a mobile device having a program product in memory thereon including several operation modules according to an embodiment of the invention;

FIG. 5C is a software flow diagram for formatting a form for user input on a user device according to an embodiment of the invention;

FIG. 5D is a software flow diagram for receiving user input and displaying products on a user device according to an embodiment of the invention;

FIG. 6 is a system database diagram for data stored in the memory of a merchant server or a database according to an embodiment of the invention;

FIG. 7A is a graphical user interface (“GUI”) displaying a product listing according to an embodiment of the invention;

FIG. 7B is a GUI displaying a contact list to choose a recipient to share a product page with according to an embodiment of the invention;

FIG. 7C is a GUI displaying a shared product page between the user and one or more recipients according to an embodiment of the invention;

FIG. 7D is a GUI displaying a comment entry text box and keyboard according to an embodiment of the invention; and

FIG. 7E is a GUI displaying a payment confirmation display and product suggestions according to an embodiment of the invention.

### DETAILED DESCRIPTION

To address the needs discussed above, embodiments of the invention may provide a user with a personlized list of products for sale, allow the user to share and navigate the list with one or more recipients and recipient devices, and create an interested network of potential buyers for sellers of goods, services and other products, including those selling custom, vintage or limited edition goods. To achieve this, in some embodiments, the invention performs the steps of: requesting user social media site login information; connecting to a social media site analytics program, such as Facebook's OpenGraph to analyze the user's likes, status updates, and attended events and look for recurring words to collect a particular number of user interests; associating the interests and available demographic information on the profile with the user to create user preferences; comparing product descriptions with user preferences; analyzing the comparison for the best match between the user preferences and the product descriptions; delivering a customized product page to the user with products that have at least a 50% match or other suitable percentage match to user preferences; and refining customized product pages presented to the user by the user's ratings of products and product purchases. Once a product list is chosen for the user, the user may share the product list with one or more contacts listed on the site, in a user device address book, stored in the system or programmed into a user interface for sharing a product or a list of product with a recipient in real time. Moreover, in some embodiments, the user may interact with the application the recipient receives. For example, in some embodiments the user may scroll through the list of products sent to the recipient and viewed on the recipient's device using a similar display on the user's device. Moreover, the invention may be used by users and sellers to tailor a group of users to offer a product to fans, contacts or friends listed in the social media site or stored in the system. For example, embodiments of the invention may be used to connect the user's network to a limited edition or vintage item, or to connect the fans of a business with special offers, discounts, events, etc.

As will be understood by those of skill in the art, the term merchant computer and merchant network may be a computer or network associated with a particular merchant selling products or a hosted website, that enables one or more persons or companies to sell goods thereon. As such, the term seller and seller computer may be a person or company that has a listing on the hosted website, or a manufacturer that is distributing goods to the person or company for sale using the merchant computer. For example, the seller may be companies such as Levi's®, Sony®, etc., that distribute products to a merchant associated with the system (the merchant associated with the system ships product), while in other embodiments the seller may be a vintage and antique store, private person and/or artisan selling single items or limited edition items, or retailers and companies such as Levi's®, Sony®, Gap®, etc., that have postings or listings for products on a hosted site to thereby distribute product for same (the seller ships product). Moreover, the terms merchant and seller as used herein should not be limited to a single merchant or seller, but many also include manufacturers, distributors, online retailers, private persons and others selling both new and used products as would be appropriate for a given application. In addition, the term “product” is not limited to physical items, but may include services, discounts, rebates, coupons, gift certificates, and/or any other item that may be traded for value such as another item, or purchased by the user. Accordingly, though the invention may be described with reference to a “product page,” “product listing” and “product purchase” such pages, listings and purchases also include such services, discounts, rebates, coupons, gift certificates, and/or any other item that may be traded for value such as another item or purchased by the user.

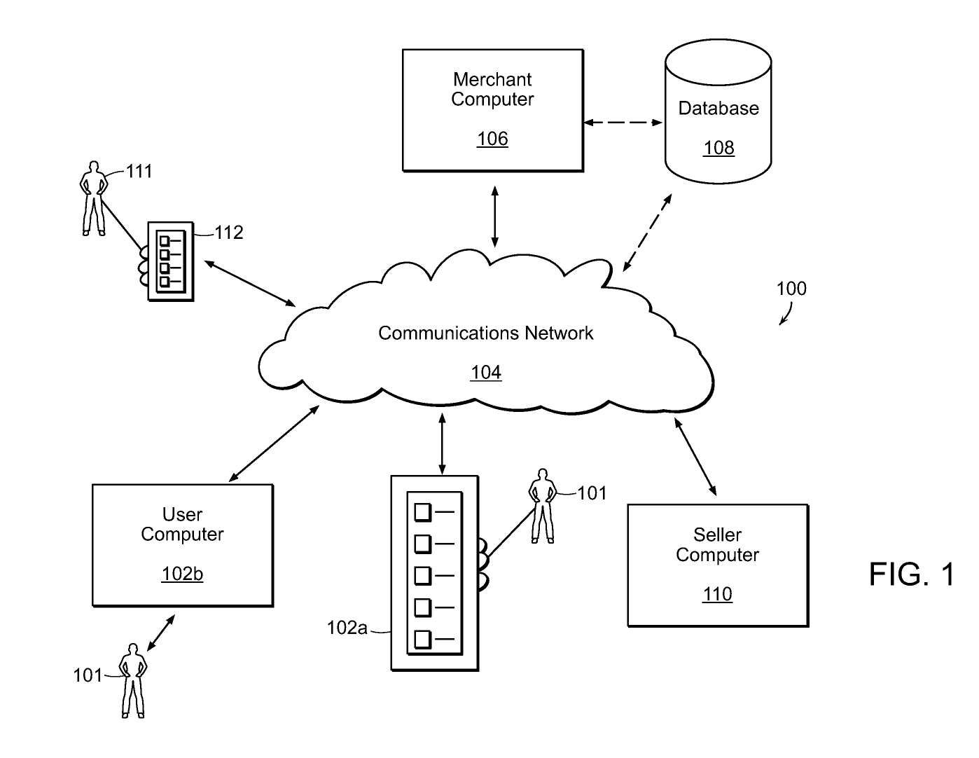

More specifically, as can be seen in FIG. 1, the system 100 of the instant invention includes user device 102a or user computer 102b associated with a user 101, a communications network 104, a merchant server 106 connected to a database 108, a seller computer 110, and a recipient device 112 associated with a recipient 111 (who receives user content as described below). As one skilled in the art will appreciate, the seller computer 110 and recipient device 112 can be any computing device capable of connecting to the communications network 104 and receiving data from same to enable system interaction with a seller (not shown) or the recipient 111 to receive information regarding products for sale. For example, seller computer and recipient device may be a desktop, laptop, personal digital assistant (PDA), cellular telephone such as a Smartphone, computer tablet, networked computer display, computer server, WebTV, as well as any other electronic device.

Moreover, though in a preferred embodiment, user device 102 is a Smartphone, user device 102 is not limited to a Smartphone, and can be any type of computing device capable of connecting to the communications network 104 and receiving data from same to enable system interaction with user 101. For example, the user device 102 may be a desktop, laptop, mobile device, PDA, computer tablet, networked computer display, WebTV, as well as any other electronic device adapted for use in the system. As such, the user device 102 is connected to the merchant server 106 via communications network 104, which may be a single communications network or comprised of several different communications networks, that connect the system. As one skilled in the art will appreciate, in a preferred embodiment, communications network 104 establishes a computing cloud (e.g., the software implementing the merchant server, database and application are hosted by a cloud provider and exists “in the cloud”). The communications network 104 can be a combination of a public or private network, which can include any combination of the internet and intranet systems that allow a plurality of system users to access the merchant server 106. For example, communications network 104 can connect all of the system components using the internet, a local area network (“LAN”) such as Ethernet or WI-FI, or wide area network (“WAN”) such as LAN to LAN via internet tunneling, or a combination thereof, using electrical cable such as HomePNA or power line communication, optical fiber, or radio waves such as wireless LAN, to transmit data. As one skilled in the art will appreciate, in some embodiments, user device 102 may be connected to the communications network using a wireless LAN, but other users may be connected to the merchant server 106 via a wired connection to the internet (e.g., to set up an account from a desktop or laptop computer). In other instances, a user may connect to the merchant server 106 using wireless LAN and the internet to set up an account. Moreover, the term “communications network” is not limited to a single communications network system, but may also refer to several separate, individual communications networks used to connect the user device 102 to merchant server 106. Accordingly, though each of the user device 102 and merchant server 106 are depicted as connected to a single communications network, such as the internet, an implementation of the communications network 104 using a combination of communications networks is within the scope of the invention.

As one skilled in the art will appreciate, the communications network interfaces with merchant server 106, preferably via a firewall (not shown) and web server (not shown) to provide a secure access point for users 101 and to prevent users 101 from accessing the various protected databases in the system. In some embodiments, the firewall may be a network layer firewall (i.e., packet filters, application level firewalls, or proxy servers). Although in a preferred embodiment a packet filter would block certain source IP addresses, in some embodiments, a packet filter firewall can be used to block traffic from particular source ports, destination IP addresses or ports, or destination service like www or FTP. In other embodiments, an application layer firewall may be used to intercept all packets traveling to or from the system, and may be used to prevent certain users from accessing the system. Still, in other embodiments, a proxy server may act as a firewall by responding to some input packets and blocking other packets.

Returning to FIG. 1, database 108 communicates with and uploads data to the user device 102 via the merchant server 106 and communications network 104. As such, database 108 may be, for example, one or more computers, file servers or database servers implemented as network attached storage (NAS), storage area networks (SAN), or direct access storage (DAS), or any combination thereof, or of other systems, comprising for example multiple hard disk drives. Moreover, each of these file servers or database servers may allow users, seller or manufacturer users to upload data to the database. For example, a user may upload a username, password, address, credit card information, shipping address information, etc, and a seller may upload product data, product price data, discount data, shipping cost data, etc., to be stored in separate file servers or the same file server, in a plurality of databases, tables, or fields in separate portions of the file server memory. Accordingly, as is known in the art, the computer-implementing database 108 may have stored thereon database management system (e.g., a set of software programs that controls the organization, storage, management, and retrieval of data in the databases). As one skilled in the art will appreciate, in some embodiments, database 108 may be stored in the merchant server memory (to be discussed below). As one skilled in the art will also appreciate, though database 108 is depicted as connected to, or as a part of, the merchant server 106, not the communications network 104, the database 108 may be, for example, connected to remote storage via the cloud or connected to the merchant server 106 via a privately networked system.

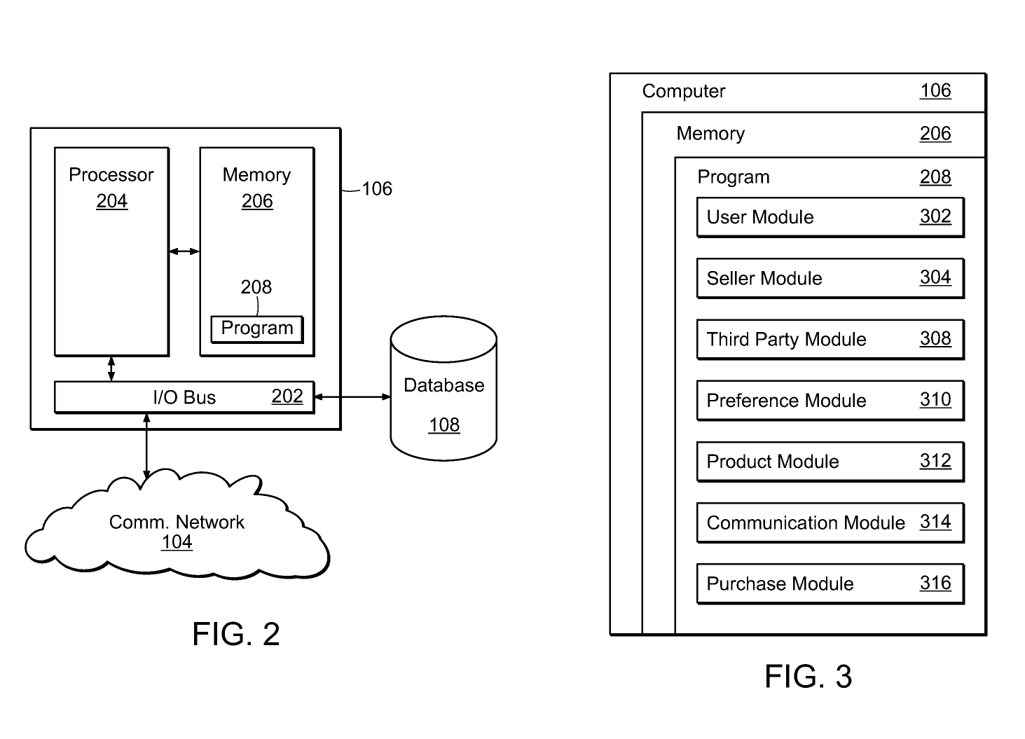

Merchant server 106 will now be described with reference to FIG. 2. As one skilled in the art will appreciate, merchant server 106 can be any type of computer such as a virtual computer, application server, or a plurality of computers. As such, merchant server 106 may comprise a memory 206, a program product 208, a processor 204 and an input/output device (“I/O device”) 202. I/O device 202 connects the merchant server 106 to a signal from the communications network 104, and can be any I/O device including, but not limited to a network card/controller connected by a PCI bus to the motherboard, or hardware built into the motherboard to connect the merchant server 106 to various file servers or database servers implementing database 108.

As can be seen, the I/O device 202 is connected to the processor 204. Processor 204 is the “brains” of the merchant server 106, and as such executes program product 208 and works in conjunction with the I/O device 202 to direct data to memory 206 and to send data from memory 206 to the various file servers and communications network. Processor 204 can be, for example, any commercially available processor, or plurality of processors, adapted for use in merchant server 106 (e.g., Intel® Xeon® multicore processors, Intel® micro-architecture Nehalem, AMD Opteron™ multicore processors, etc.). As one skilled in the art will appreciate, processor 204 may also include components that allow the merchant server 106 to be connected to a display (not shown) and keyboard that would allow, for example, an administrative user direct access to the processor 204 and memory 206.

Memory 206 may store the algorithms forming the computer instructions of the instant invention and data, and such memory 206 may consist of both non-volatile memory such as hard disks, flash memory, optical disks, and the like, and volatile memory such as SRAM, DRAM, SDRAM, etc., as required by embodiments of the instant invention. As one skilled in the art will appreciate, though memory 206 is depicted on, for example, the motherboard, of the merchant server 106, memory 206 may also be a separate component or device connected to the merchant server 106. For example, memory 206 may be flash memory or other storage.

As shown in FIGS. 2 and 3, an embodiment for computer instructions implementing some of the functionality of the instant invention is stored in memory 206 (e.g., as a plurality of programming modules). Turning now to FIG. 3, the programming modules for the program product include user account set-up module 302, a seller account and product upload module 304, a third party module 308, a preference module 310, a product module 312, a communications module 314 and a purchase module 316. The user account set-up module 302 includes instructions for setting up a user account, including, for example, a username, password, credit card information, merchant and product preferences, billing address, and one or more shipping addresses. As one skilled in the art will appreciate, the user account set-up module 302 may include options for the types of coupons, discounts, or other merchant information the user 101 wishes to receive with product preferences. For example, the user 101 may only wish to see products that match their preferences and have merchant discounts that exceed a certain percentage of the price for the item, in other instances, a user 101 might wish that the products sent to the user 101 be ranked according to discount amount, price or match to preferences. Accordingly, the user account set-up module can include prompts that enable the user to set such preferences. The user account set-up module 302 may also include a link to a mobile device application (discussed below) for the user to download to their mobile device. Alternatively, in some embodiments, the user may initiate the application and program set-up through an application store or database of applications for purchase.

The seller account and product upload module 304, for example, can include instructions for enabling a seller to upload products to the merchant server to sell, manage sales of products, track inventory sold through the site, manage the receipt of payments through the merchant computer, and offer discounts to purchasers of the products. For example, a seller may wish to offer a discount to every user that has viewed a product page for a certain length of time, or offer a discount to a user that is in the process of conversing with a third party recipient on whether to make a purchase. In such instance, the seller module may include preference choices such as offer a 5% discount when the customized product page has been open 5 minutes and a user is sharing the product with a recipient in real time. The seller module may also offer other features to sellers, including for example, photo upload options, volume discount options, inventory discount options, etc. Alternatively, in some embodiments, the seller module may allow the seller to link products together for suggestions to the user. For example, if a user is in a conversation with a recipient of the customized product page over a particular feature of the product, the seller may set product key words that would enable the program to suggest other seller products that might be more tailored to the user comments (to be discussed below in more detail). In this regard, the seller module would offer the seller the ability to set preferences that entice customer sales through both discounts and product suggestion.

Returning to FIG. 3, the third party module 308, for example, can include instructions for linking to the user's profile pages on third party social media sites such as Facebook®, MySpace®, LinkedIn®, Twitter®, Google+®, etc., to post comments on their associated profile page regarding purchases made from or products listed on the user's customized product page. In some embodiments, the user may be offered an additional discount for the posting a favorable comment regarding a product or service or a recent purchase to the third party site. For example, the user may send a customized product page to a recipient to chat in real time about the product, and if the comments about the product are favorable, may receive a discount on the purchase price of the product for posting the comment on their profile page with a third party site. In other embodiments, the user may receive a discount for posting a product purchase on the third party site. As one skilled in the art will appreciate, a merchant would be able to use such tools to entice the sale (with the discount), and advertise to the friends and colleagues of purchaser the product preference.

The preference module 310, for example, can includes instructions for the user to manually set product preferences or to link to third party social media sites such as Facebook®, MySpace®, LinkedIn®, Twitter®, Google+®, etc., to extract user preference data. Accordingly, in some embodiments, the user may be asked to submit which types of products they would like to see included in any customized product page for the user. In such embodiments, the user may be asked, for example to enter the type of product such as electronics, women's clothes, shoes, hair products, sports equipment, books, spa services, etc., and/or a product manufacturer such as Sony®, Ann Taylor®, Proctor & Gamble®, etc. that the user prefers. In other embodiments, the preference data may be extracted from third party social media sites. For example, a user's Facebook® page may include several products that the user has liked, or there may be keywords on the page that indicate a user's product preferences. In this regard, the instructions may search for references to a user's lifestyle, family status, etc. to determine the types of products the user might be interested in purchasing. For example, if a user has a photo with a caption indicating it is their 12-year-old daughter playing softball, the instructions may determine that a user preference is children's softball equipment, shoes, etc., and offer products tailored to that preference. In other instances, the instructions may determine that the user's status is single and from photo captions or comments on the user's page that the user spends time at bars and restaurants with friends. In such instances, the instructions may determine that a user preference is discounts for nightclubs, movies or restaurants. Moreover, the preference module 310 may use analytics on third party social media sites to set user preferences. For example, the preference module 310 may execute the steps of: connecting to Facebook's OpenGraph by using a user Facebook login, analyzing likes, status updates, and attended events and look for recurring words (i.e. golf, cars, shopping, etc) to collect a particular number of user interests (e.g., 5 or any other suitable number), associating interests and available demographic information (e.g., age, gender, location, marital status, etc.) with the user to create user preferences, comparing product descriptions with user preferences; analyzing the comparison for the best match between the user preferences and the product descriptions (e.g., if the user's 5 interest tags are “golf, motorcycle, rock, watches, leather” and there's a product with tags “harley, motorcycle, rock, watch, leather”, then there is an 80% match), delivering a customized product page to the user with products that have at least a 50% match to user preferences; and refining customized product pages presented to the user by the user's ratings of products and product purchases over time. For example, if the user purchases every vintage Rolling Stones t-shirt that is presented to the user, but passes on every vintage Beatles and Led Zeplin t-shirt, the system may refine the user preference from “vintage rock t-shirts” to “vintage Rolling Stones” t-shirts. Or, if the user changes his profile to indicate he is now living in San Franciso, not Houston, the system may refine the user preference from “restaurants in Houston” to “restaurants in San Francisco.” In this way, the preference module can update the customized product list to reflect the user's particular preferences and status at any given time. The user preference data may be extracted from any of the above embodiments, any other suitable embodiment, and/or any combination thereof.

Returning to FIG. 3, the product module 312, for example, includes instructions that create a customized product page for a user. As one skilled in the art will appreciate, the customized product page may be created when the user connects to the service by logging into the user's account with the merchant server, when the user requests such page is refreshed, for example, after logging into the account, and/or may be emailed to a user email account daily. In some embodiments, the customized product page includes a list of products that match the user preferences as extracted above and keywords related to products listed in the database by the seller. In this regard, some embodiments may include instructions to extract from the seller's product description particular keywords such as product type, product manufacturer), product size if applicable, gender, if applicable, price, discounts, color, etc. For example, the product type may be a radio, television, computer, pants, etc., and the product manufacturer may be Sony®, Apple®, Gap®, etc. From these keywords, the product module may include instructions to both match one or more of the user preferences and disqualify a match that does not match other user preferences. For example, if the user is a man that likes pants from the GAP®, the instructions may exclude women's pants from the GAP® from the customized product page based upon a failed gender match even though there was a match for pants from the GAP®.

The communications module 314, for example, can include instructions for allowing the customized product page to be shared between the user and a recipient designated by the user. In some embodiments, the customized product page may include a link to share same. In such embodiments, the communications module 314 would include instructions to prompt the user for the recipient's telephone number or email address and would text or email a link to a hosted customized product page to the recipient (and refresh the user's page with the hosted page). As one skilled in the art will appreciate, in some embodiments the hosted page would enable real time communications between the user and the recipient over the page and for example, would allow the user and recipient to chat over the customized product page.

Finally, the purchase module 316, for example, can include instructions for processing a payment from the user to the seller. As such, the purchase module 316 may operate in conjunction with PayPal®, VISA®, MasterCard® or other credit card company to process payment to the seller. In some embodiments, the user or merchant will be charged for each purchase made using the site or for access to the site and software. For example, a seller or user may be charged 500 for each transaction, $3.99 to download the associated mobile application, and/or may be charged a monthly fee to use the service. In other embodiments, the merchant may pay the service to have its products posted higher in users' customized page listing or for product suggestions based on user comments to be offered from the merchant's product listings. In other embodiments, the purchase module 316 may include instructions for charging the user a portion of the discount received by using the service, e.g., 10% of the savings value is credited to operator of the merchant server. In such embodiments, for example, the user may have received a 15% total discount for purchases made from the customized product page, then the system would be credited a payment of 10% of the savings or 1.5% of the sales value.

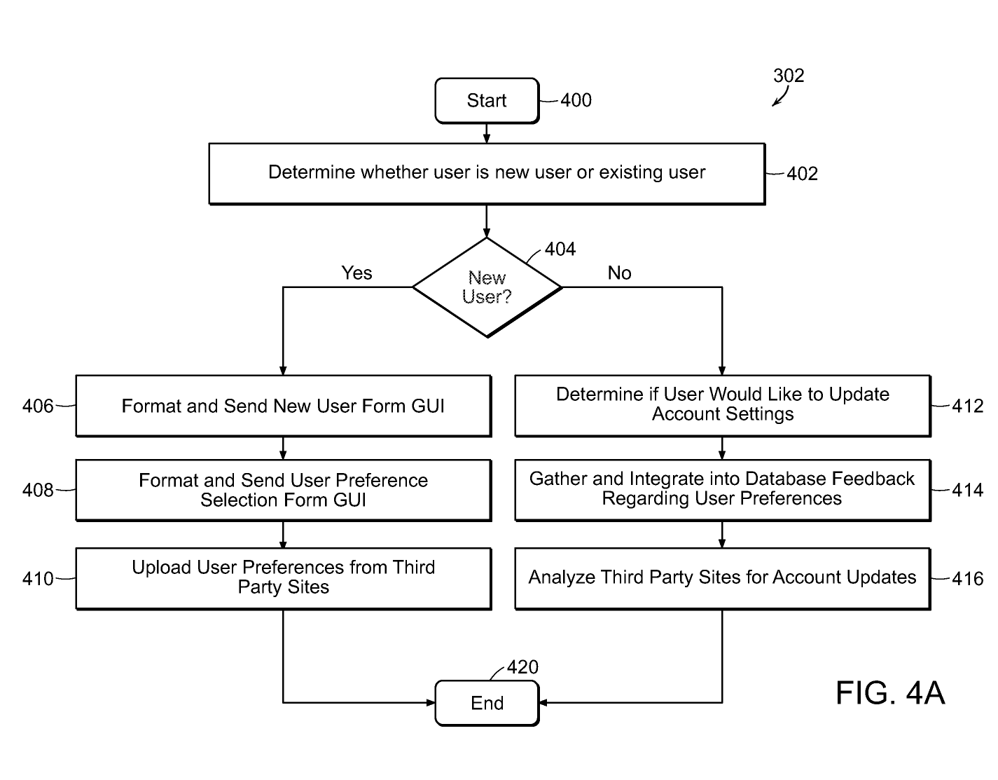

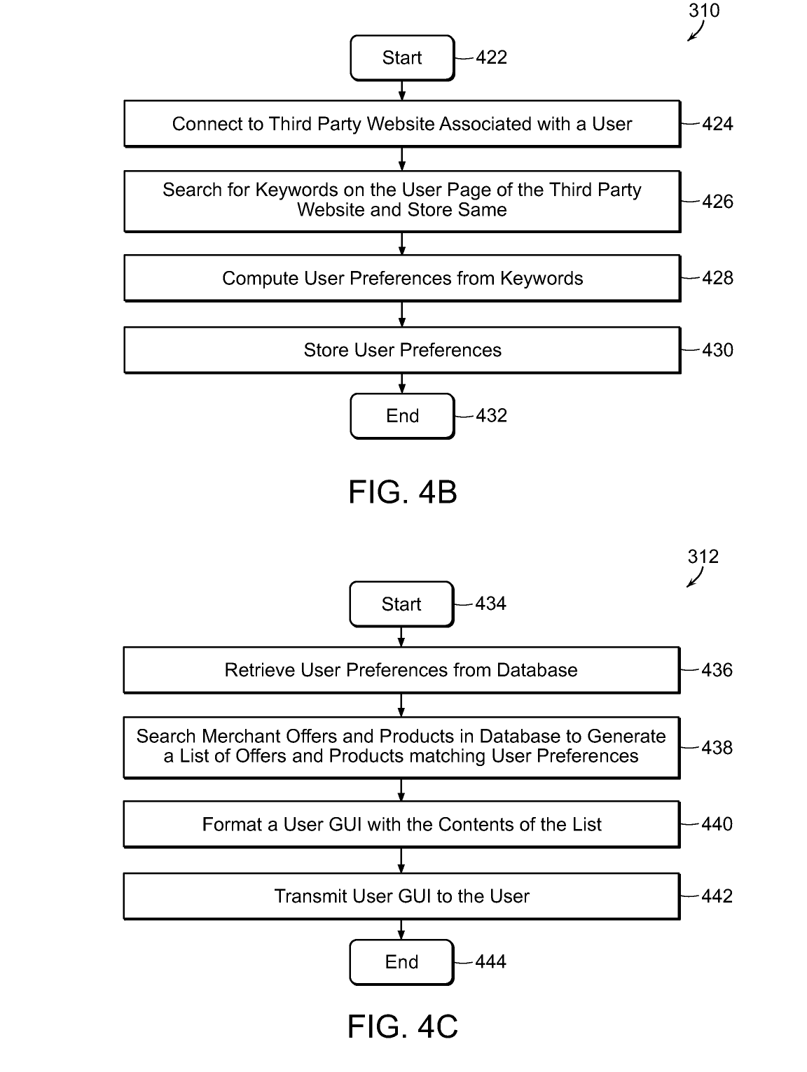

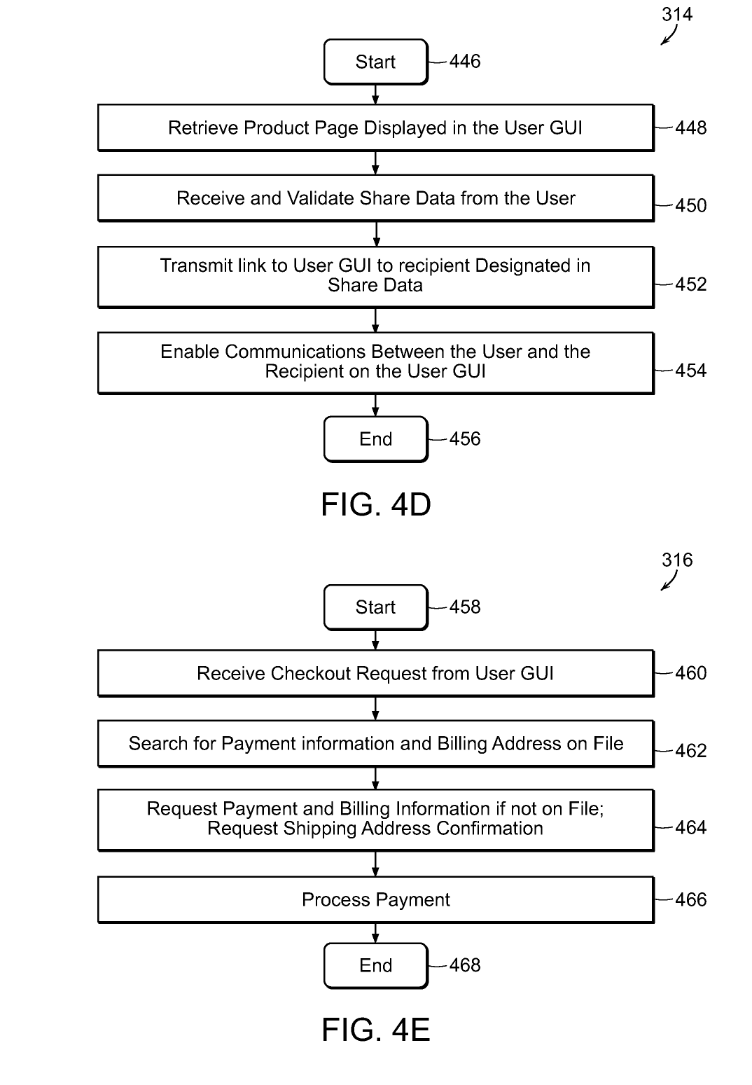

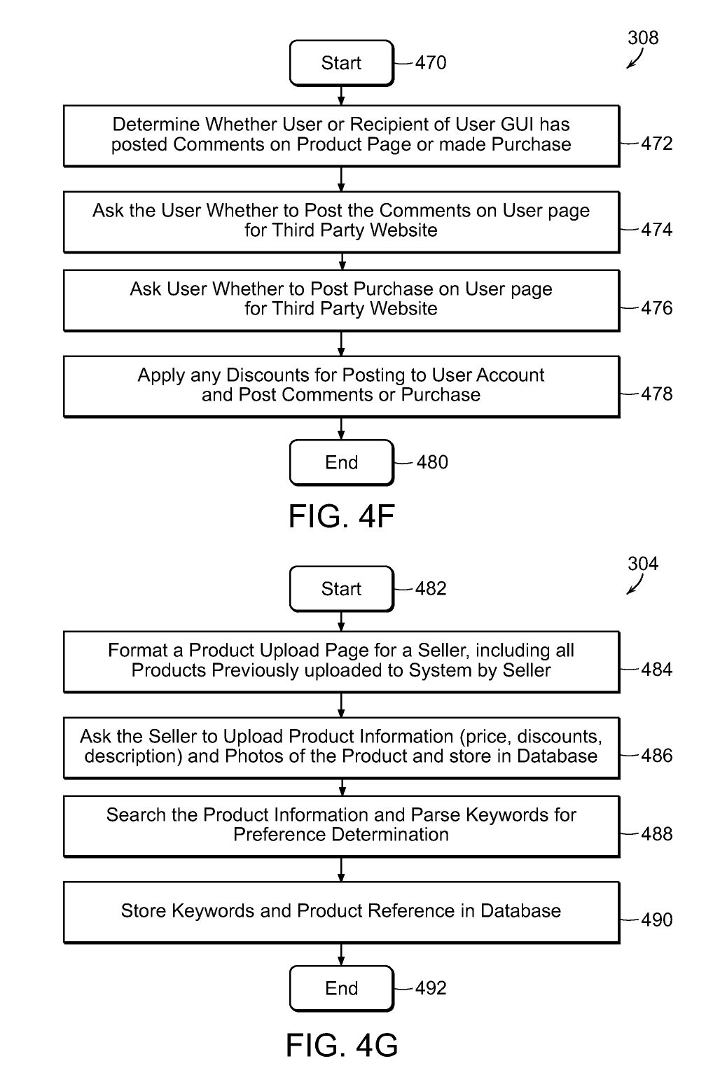

An exemplary embodiment of the computer program flow for processes implementing the user account set-up module 302, seller account and product upload module 304, third party module 308, preference module 310, product module 312, communications module 314 and purchase module 316 will now be discussed with reference to FIGS. 4A-4G. As one skilled in the art will appreciate, through the flow diagrams are shown as implemented in a serial configuration (or a combination of serial and parallel configurations), such flow is for simplicity only and should be understood to include various loops and process that may be run concurrently and/or used to implement each of the instructions, or a plurality of the instructions, therein.

To implement the user account set-up module 302, the process starts at step 400. At step 402, the user is provided a form to indicate whether the user is a new or existing user. As one skilled in the art will appreciate, such a form may be provided as part of an application, or app, installed on the user's Facebook® profile, user device or may be a graphical user interface (“GUI”) transmitted from the merchant server to the user computer or mobile device. In this regard, for example, the user may connect to the app from their user profile page or a system entry form or the GUI may ask the user to provide a username and login address. If the user is a new user, the entry form or GUI may ask the user to check a box requesting a new user form. In step 404, the process determines whether the user is a new user or an existing user from the data input into the entry form or GUI (e.g., the system determines whether the login and password match a user account or whether the user would like a new user form). If the user is requests a new user form, the new user form is sent to the user as a GUI or is loaded from the app installed on the mobile device, in step 406. As one skilled in the art will appreciate, the new user form may include prompts for information such as the user's name, billing address, preferred shipping addresses, credit card information, third party social media sites associated with the user, user phone number, user email address and the email address or mobile phone number of any recipients of the user content (e.g., friends, family and colleagues designated to receive product pages from user). In this regard, the content in the form may be marked as necessary for registration and unnecessary for registration. For example, the user name, email address and address for at least one third party social media site may be required for the user to register an account with some invention embodiments, but the billing address, credit card information, recipient email and phone numbers may be optional. Moreover, in some embodiments, the user profile page may also include tabs to export one or more contacts from web based email social media sites into the system (e.g., Facebook®, Gmail® or Linkedln® contacts).

Once the new user form is completed by the user, the data therein is uploaded to the merchant server and a user preference selection GUI is displayed on the user's mobile device in step 408. The preference selection GUI may include, for example, products or brands the user likes, products or brands the user dislikes, style choices, color and size selections, general product needs, or any other selection that may help the merchant server narrow products selection. For example, the user may select style choices such as hipster, traditional, 50's mod, etc. or product needs such as shampoo every month, new t-shirts every 6 months, etc. Moreover, similarly to the forms discussed above, in some embodiments, the user preference selection form may be part of the application downloaded onto the mobile device while in other embodiments the new user form may be received from the merchant server. And, in some embodiments, the new user form and preference form may be moved between screens using tabs or other selection indicators, or the new user form and the preference form may be part of the same GUI. Moreover, in a preferred embodiment, the preference selection GUI may be presented to the user only after user preferences have been extracted from the user's social media profile page so the user has the option to change preference selections. For example, if the system determines the user would like to receive discounts for bars the user seems to frequent based upon data on the user's profile, but the user no longer drinks, the user can deselect this preference. Accordingly, though not all embodiments for the new user form and preference form are discussed herein, all should be considered part of the disclosure. In step 410, the user account set-up module 302 uploads user preferences from third party social media sites (using the preference module 310 discussed in detail below).

Returning to FIG. 4A, the steps that the module may implement when a user is identified as an existing user will be discussed. In step 412, the user account set-up module presents the user with the option to update user profile and preference settings (e.g., to add a new products preference, to update contact information, change a user password, etc.). As one skilled in the art will appreciate, a user profile tab and user preference tab (or other selection tool) may be used to connect the user to the existing user profile form and user preference form for the user (e.g., the form originally filled out by the user may be presented as a GUI for the user to make changes thereto). In step 414, the instructions for the user account set-up module include gathering and integrating into database feedback regarding user preferences. For example, customized product pages for the user can be presented with links to deselect items, product types or manufacturers from the user preferences so that the user will not be presented with similar products in the future, or the customized product page may include links to rank a product favorably so that items from the same manufacturer or product type may be presented to the user in the future. In some embodiments, the gathering of feedback may include deselecting a product type once a user has made a purchase (e.g., if the user is presented with offers for a new computer, enabling the user to deselect computers after the purchase). Returning to FIG. 4A, in step 416 the user account set-up module analyzes third party social media sites for preference updates. In some embodiments, the user profile module may ask the user if they would like to reanalyze such third party social media sites when the user updates account or preference data. However, as one skilled in the art will appreciate, the merchant server may also update preference data by polling third party social media sites associated with the user at regular intervals, at user login, or at any other time that the system may designate that an update is needed. As such, updating user preferences by polling such sites may not be limited to a process step within the user account set-up module in some embodiments. Finally, in step 420, the process ends.

Turning to FIG. 4B, the preference module 310, is described. In step 422, the process starts and in step 424 the preference module connects to third party social media sites associated with the user as entered in the user preference form. As described above, such third party social media sites may include Facebook®, MySpace®, LinkedIn®, Twitter®, Google+®, etc., which allow a user to post a profile, and add content thereto. In step 426, the preference module searches for keywords on the user profile page and stores same. For example, in some embodiments, the app may interact with the user using Open Graph in Facebook® to thereby generate the user preferences by tracking user activity within the app. In some embodiments, the keywords may include product names, product brands, relationship status, occupation, children's ages and/or activities, restaurant names, band or concert names, sports teams, gender, birthdays (the user and relatives and close friends), anniversaries, etc. As one skilled the art will appreciate, over time, system keywords in a user profile can form a predictive pattern for user preference. For example, a married woman with two kids in sports may identify the start of a sport's season each year through blog posts or photos about attending her children's games, or a single man that likes a particular college football team may have an increase in blog posts, updates, etc. mentioning the team every fall. In this way, the preference module may not just look for keywords in step 426, but also for dates and frequency of the keywords in the user profile to indicate when a user would be the most suggestive to the purchase of certain product (e.g., sports equipment for the mother and college t-shirts for the single man). Once keyword data is collected, in step 428, user preferences are computed by associating one or more keywords with a product the user may wish to purchase. As mentioned, because profiles contain information not just related to keywords, but also the frequency and dates of keywords, in some embodiments a user might have different preferences in the database based upon the time of year. In step 430, the user preferences are stored in the database and in step 432, the process ends.

Turning to FIG. 4C, the product module 312 is described in more detail. In step 434, the process starts and in step 436 user preferences from the database are retrieved. As described above, the user preferences may be gathered from the user preference form and may be calculated from keywords gathered from third party websites. In step 438, seller offers and products in the database are searched to generate a list of offers and products that match the user preferences. As one skilled in the art will appreciate, some embodiments may require a multiple point match for a product to be included in the list. In other embodiments, a match may be excluded based upon preferences that are not matched (e.g., clothing associated with a different gender than the user). Once the preference list is generated, the product module formats a customized product page including the products in step 440. As one skilled in the art will appreciate, the customized product page containing the products may be formatted as a GUI accessible via the communications network and/or as an email message. In step 442, the message is transmitted to the user via the communications network and the user has the option to provide the merchant server with a customized page. In this regard, the customized product page may include one or more of the products matching the user's preferences (e.g., organized by product, product category, price, chosen products, etc. according to the user's preference). As one skilled in the art will appreciate, the customized product page essentially allows the user to filter matched preferences down to the products the user is considering purchasing, and in this regard communicate a condensed product page to a recipient (to be discussed further below). In step 444, the process ends.

Turning to FIG. 4D, the communications module 314 will be described. In step 446, the process starts and in step 448, a customized product page is displayed to the user. As one skilled in the art will appreciate, the customized product page may be a listing of products matching the user's preferences, a sub-set of the products matching the user's preferences or may be product listing that the user has saved a to be accessed in the future. As such, the customized product page may be created and/or accessed via user initiation on the user's Facebook® profile, the application home page on the mobile device or after the user login's into the merchant server, or the mobile device may be accessed via a link on an email sent to the user's email address or text to the user's mobile phone containing the customized product page, an option to create a subset of the customized product page or a link to a saved customized product page. As such, the customized product page may include a list of products matched to the user's preferences, a category of products matched to the user's preferences, a group of products selected by the user and matched to the user's preferences, suggested products, etc. In step 450, the user may link to a recipient the user's contact list or provide share data for the recipient to share the customized product page. Share data, for example, may include a recipient's name, email address and/or phone number. In some embodiments, the share data may be validated by the merchant server (e.g., matched to known user accounts for the merchant server so the customized product page in the app environment). Moreover, in some embodiments, the recipient may be selected from an address book of contacts added to the user's profile on the user profile page, and in other embodiments the recipient's name, email address and phone number may be entered from the user's customized product page. In step 452, the customized product page is sent to the recipient, for example, via an email link, an update to an icon for the app loaded on the recipient device, a text link, etc. In a preferred embodiment, the user is not sending the actual pictures to recipients in an email or text, but small packets of information that include picture numbers to be installed in cached memory associated with the recipient (e.g., in the cloud, mobile device memory, etc.). In this way, once a recipient opens up the app the user's product list will be available to the recipient and the recipient can browse the product list by cache reference. Once the recipient accesses the customized product page, the recipient and the user can communicate over the product page in step 454. For example, in some embodiments, the user and recipient may post comments or a symbolic link related to whether the user should purchase the product. For example, a symbolic link can include an emoticon, a checkmark, a hash mark, etc. Moreover, in some embodiments, the comments related to the product may be published as part of the product description (e.g., appearances of the product on other user's customized product pages will include such comments). In step 456, the process ends.

Turning now to FIG. 4E, the payment processing module will be described. The process starts in step 458, and in step 460, a checkout request is received from a user checkout GUI, which may include a list of products the user would like to purchase or a link to the list of items the user would like to purchase stored in the database. As one skilled in the art will appreciate, a portion of the checkout GUI may be included as part of the application installed on the mobile device (e.g., a checkout button or payment information GUI), or may be provided by the merchant server when the sends a check-out request (e.g., the user's mobile device accesses the GUI through the merchant server). In some embodiments, the checkout GUI may include data prompts for information such as shipping address, preferred shipping method (e.g., next day, two day, bulk rate, standard, etc.), preferred shipping carrier (e.g., U.S. postal service, UPS®, FedEx®, etc.), and/or credit card information including the credit card holder name, number, card verification value (CVV) code, billing address, etc. Moreover, in some embodiments, the checkout GUI may include an inventory of products being purchased, the total cost of the items being purchased, the amount of tax being charged for the purchase, the total amount charged to the user's credit card, for example the total cost, tax and any service surcharges, an estimated shipping date, an estimated arrival time for the goods purchased, and/or a verification of the shipment carrier and method. Moreover, in some embodiments, the user may checkout by clicking or tapping a checkout button and using the user's billing, shipment, and credit card information on file.

Returning to FIG. 4E, if the user selects to use the credit card information the user has on file with the merchant server, the merchant server matches the user with the payment and billing information on file in step 462, and provides the user with a payment confirmation GUI (to be discussed further in regard to step 466 below). For example, the database 108 connected to the merchant server may store the IP address of the mobile device in memory and determine a match by matching the IP address associated to with the user's mobile device with the IP address for the user stored in the database. In other embodiments, merchant server may associate the user's login information with a valid request. Moreover, the merchant server may use the IP address of the mobile device to establish a secure connection for payment processing, or to confirm a user purchase for a user that is logged into the merchant server. For example, the user may receive the data on the checkout GUI. In step 464, if a user checkout request is received, and the checkout GUI does not include billing and payment information with the request, such as when the merchant server receives an initial checkout request to establish a secure connection, the merchant server provides a merchant checkout GUI to the user to receive payment an billing information on a secure form. As one skilled in the art will appreciate, steps 460, 462, and 464 may be run concurrently or in the alternative. For example, if the application installed on the mobile device includes a GUI with prompts for payment and billing information, the mobile device may establish a secure connection to the merchant server and then transmit the payment information (e.g., the merchant server established an electronic handshake). In other embodiments, the user may submit a checkout request to the merchant server, and the merchant server may transmit a prompt to the user asking whether the user would like to use the credit card information and shipping address on file or enter new information. In such embodiments, the merchant server transmits the checkout GUI after it is requested. Accordingly, though the purchase module 316 includes each of these steps in series, this disclosure should not be so limited. Finally, in step 466, the purchase module 316 executes steps to process the payment for the products in the checkout GUI and sends a payment confirmation. For example, the payment confirmation may include the user's shipping address, preferred shipping method preferred shipping carrier, credit card information, billing address, an inventory of products being purchased, the total cost of the items being purchased, the amount of tax being charged for the purchase, the total amount charged to the user's credit card, an estimated shipping date, an estimated arrival time for the goods purchased, a verification of the shipment carrier and/or an additional method to confirm the transaction before payment is processed. In some embodiments, the payment confirmation can be a GUI that requires the user to confirm the transaction before payment is processed. In other embodiments, the payment confirmation can be a receipt or proof of purchase sent after the receipt of payment information, and in some other embodiments, after the merchant receives confirmation of the transaction from the payment confirmation GUI the merchant server can send a receipt or proof of purchase to the user's mobile device (e.g., via text, email or webpage display screen). In step 468, the process ends.

Turning to FIG. 4F, the third party module 308 will be described. In step 470, the process starts and the third party module 308 determines whether the user or recipient of the customized product page has posted a comment regarding the product to the customized product page in step 472. In some embodiments, the merchant server may search for words in the posting to determine whether the posting is related to an attribute of a specific product, or whether the posting is favorable or unfavorable. For example, the user may post a comment on the customized product page that states the product is not attractive, which the system may flag as not being a comment. In another example, the user and the recipient may be discussing whether the product listed on the customized product page is attractive in appearance, price, etc.; in which case the merchant server may determine the user posting is a comment. In other instances, the user and recipient may be discussing whether the item is a size that will fit the user, fit a location for the item is the user's home, or other postings of a personal nature and determine that the posting is not a comment. As one skilled in the art will appreciate, in some embodiments the determination of whether a posting is a comment may be dependent on the use of personal articles such as I, you, me, etc., or a certain number of instances or a percentage use of personal articles. Once the third party module determines that a posting is a comment, the third party module presents the user with a prompt asking the user whether they would like to post the comment on their profile page for a third party social media site in step 474. For example, if the user likes an item, the merchant server may ask the user if they would like to post on a third party social media site that they like the item. In some embodiments, the merchant server may incentivize the user posting the comment on the third party site (e.g., offer the user a percentage discount on the item for offering a favorable review). In other embodiments, the merchant server may ask the user if the user would like the recipient's comments posted on their profile for the third party social media site (e.g., when the server determines that a posting from a recipient is a comment, the server asks the user whether to post the recipient's comment). In other embodiments, the server may only allow the recipient's comments to be posted on the user's profile page when both the recipient and the user approve the posting. Moreover, in some embodiments, the user may post the conversation with the recipient in their profile on the third party social media site, with or without the permission of the recipient.

Returning to FIG. 4F, the third party module 308 may ask the user whether they would like to post a recent purchase to their profile on the third party social media site in step 476 and in step 478 the third party module may apply any discount of other offer to the user's shopping cart for posting a comment on the user's profile. For example, in some embodiments, the user may be incentivized by offering a discount, free product or other benefit to post a purchase on their profile before the transaction is processed. In such an instance, the shopping cart GUI (described above) may include a code or prompt for posting such purchase the user's profile, the associated incentive for the comments, and/or an indication that the incentive has been applied to the purchase price of the item). In other embodiments, the incentive for posting may be received after the purchase is made (e.g., the server offers the user a discount on future purchases). Moreover, in some embodiments, no discount will be offered, but after a purchase is complete, the user may be asked whether they would like to post the purchase to their profile on the third party social media site (with or without an associated comment). For example, if a user purchases a new television, after the purchase is made the user may post a picture of the television to their profile with a comment such as “Look what I just bought, anyone for watching the game on Sunday”. In this way, a user may use the system to solicit advice from friends on third party media sites regarding a purchase, or to post status updates related to products the user likes (in this case a new purchase). In step 480, the process ends.

Turning to FIG. 4G, the seller account and product upload module 304, which allows the user to upload items for purchase to the merchant server (or merchant server database), is described. As one skilled in the art will appreciate, in instances where the merchant is offering the products for sale directly (as opposed to allowing a plurality of retailers and manufacturers to use the system), the seller module may allow the merchant to upload a new product to the system or remove an existing product from the database. If the merchant server offers a plurality of retailers, individuals and/or manufacturers to use the system, the seller module may operate so that each user can manage the items sold on the site and/or view metrics related to product sales (e.g., products sold, discount offers received and taken, advertisement and suggestion appearances for each product, page view counts, customized product pages created for its products, etc.). In step 482, the seller module is initiated when the server identifies the user as a seller, and in step 484, the module provides a seller GUI to the user for display. The seller GUI, for example, includes prompts and other tools to upload or remove products for sale on the site, all of the products offered for sale by the seller, and any metrics that may be applicable to the seller and its products. In some embodiments, the metrics may be provided on a subscription basis, and accordingly the seller GUI may include an enticement for such subscription (e.g., the seller page may include a statement such as “guess which of your products had 1000 page views . . . subscribe to find out.” In other embodiments, the metrics may be provides as a service to sellers using the site. Returning to FIG. 4G, in step 486 the seller module provides an Upload GUI to the seller so the seller may upload and download products to the server or database. For example, a prompt to upload products from the seller GUI may be chose, and the upload GUI displayed to the seller with tools to upload product information. As one skilled in the art will appreciate, however, in some embodiments the upload GUI may be included as part of the seller GUI (e.g., the dashboard may include all of the tools needed to upload products to and download products from the server and database). Moreover, in some embodiments, the upload GUI may upload a single item, or a database of items, with the necessary information to list the product for sale using the merchant server (e.g., price, product description, photos. discount amount and type, etc.). In step 488, the seller module searches the product description to parse keywords that can be used to match the user preferences. In this regard, the system may require the seller to enter certain information with each product upload. For example, price, size or dimensions, color, age, condition, and/or product type or category may be required for every item listed in the system database so that the system can appropriately categorize the products to match with each user's preferences, but the system may also allow the seller to enter this information in a narrative form (e.g., as a sales pitch for the particular item listed on the site). As one skilled in the art will appreciate, however, in other embodiments the system ask for certain information for each item in separate prompts to establish keywords but allow another prompt for a narrative description that is not parsed for keywords. Once the keywords are obtained, in step 490 the keywords and a product reference are stored in the database. For example, for each product, the database may include a table with a product reference (e.g., an alpha—numeric code) and the product keywords so the database can be searched for matches between user preferences and products more efficiently. However, as one skilled in the art will appreciate, in some embodiments all product information may also be included in the same table. In step 492, the process ends.

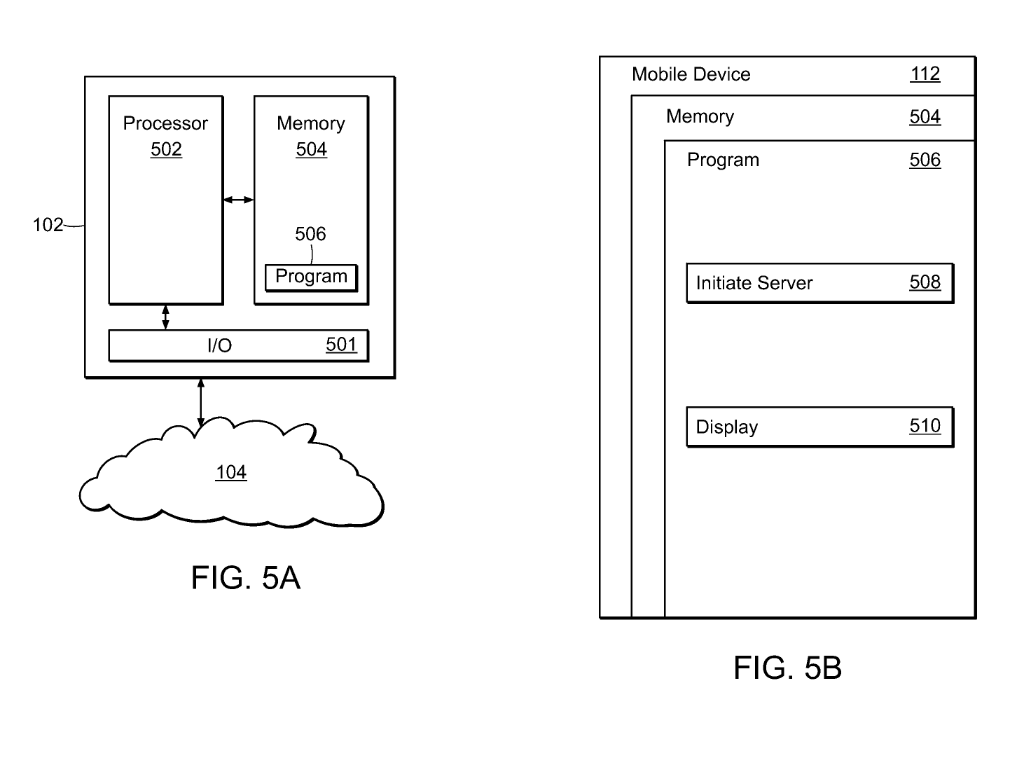

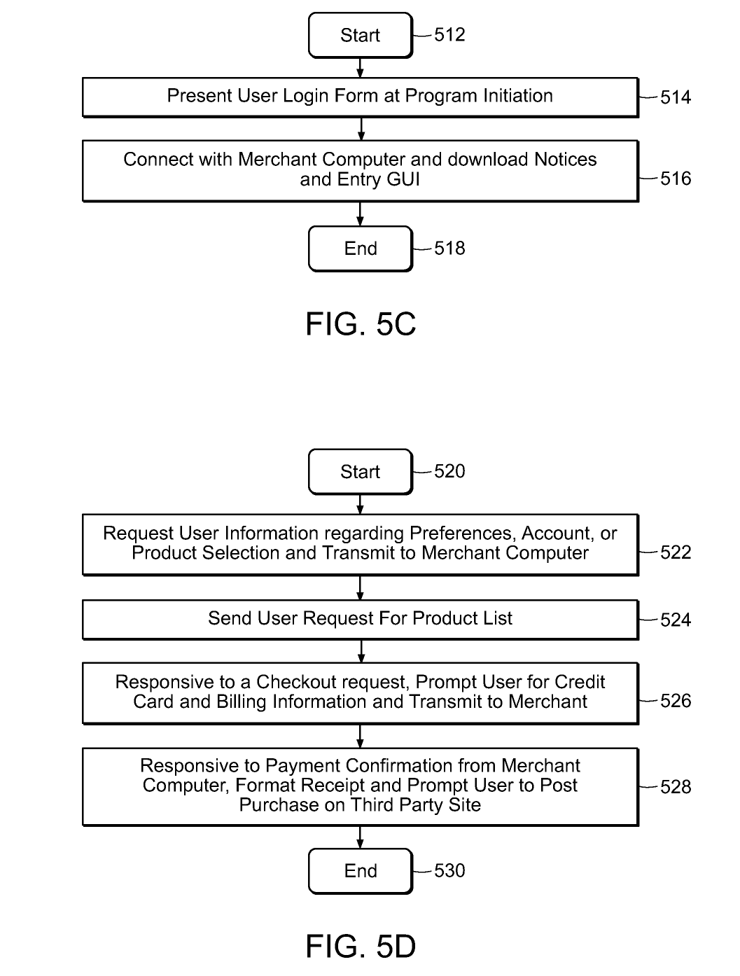

User device 102 will now be described with reference to FIG. 5A. As one skilled in the art will appreciate, user device 102 can be any type of computer comprising a memory 504, a program product 506, a processor 502 and an input/output device (“I/O device”) 501. I/O device 501 connects the user device 102 to a signal from the communications network 104, and can be any I/O device including, but not limited to a network card/controller connected by a PCI bus to the motherboard.

As can be seen, the I/O device 501 is connected to the processor 502. Processor 502 is the “brains” of the user device 102, and as such executes program product 506 and works in conjunction with the I/O device 501 to direct data to memory 504 and to send data from memory 504 to the communications network. Processor 502 can be, for example, any commercially available processor for mobile devices such as the Intel® Core 15 or AMD Turion microprocessors. As one skilled in the art will appreciate, processor 502 may also include components that allow the user device 102 to be connected to a computer via, e.g. a USB port.

Memory 504 may store the algorithms forming the computer instructions for an application (“app”) stored therein to enable system functionality, and such memory 504 may consist of internal FLASH memory, which may be NAND and/or NOR type, as required by embodiments of the instant invention. As one skilled in the art will appreciate, though memory 206 is depicted on the motherboard, of the user device 102, memory 504 may also be a separate component or device such as additional FLASH memory, SD card, or other storage, connected to the user device 102.

As shown in FIG. 5B, an embodiment for computer program 506 implementing some of the functionality of the instant invention is stored in memory 504, (e.g., as a plurality of programming modules). The programming modules for the program product 506 include an initiation module 508 and a display module 510. As one skilled in the art will appreciate, the initiation module 508 and display module 510 may be uploaded to the mobile device as an application (“app”) for the mobile device for use in conjunction with website associated with the merchant server 106. For example, the initiation module 508 can be installed on the mobile device to log the device into the merchant server using, for example, the mobile device's IP address or the user's entries into a log in page installed as part of the program. In some embodiments, the initiation module may include a screen display that indicates the app is receiving information from the merchant server (e.g., an hourglass or clock icon). The display module 510 is provided to receive user input and format mobile display device for the receipt of data from the merchant server. In some embodiments, the display module may include several user input GUI's or forms that include prompts for user input, such as user preferences, product searches, user comments, and a checkout prompt (to be provided with data from the merchant server), etc., as may be required by the application. In some embodiments, the app may include format data for screen displays that are provided to the mobile device from the merchant server (e.g., frame size, font type, position information for product displays, etc.).

Turning to FIGS. 5C and 5D, an exemplary embodiment of the computer program flow for processes implementing the initiation module 508 and a display module 510, respectively, will now be discussed. As one skilled in the art will appreciate, through the flow diagrams are shown as implemented in a serial configuration, such flow is for simplicity only and should be understood to include various loops and process that may be run concurrently and/or used to implement each of the instructions, or a plurality of the instruction, therein.

As shown in FIG. 5C, the initiation module 508 starts in step 512, and the user is presented with a login form at program initiation in step 514. In some embodiments, the login form includes such information as the user's username and password, which may be saved for future initiations of the program. In other embodiments, upon initiation of the app, the mobile device may transmit its IP address to the merchant server for user verification. For example, on the first initiation of the program, the user may be prompted for a username and password, but in subsequent initiations of the program, the app transmits a saved user name and password or the mobile devices IP address to access the user's account with the merchant server. Moreover, in some embodiments, the app may display a screen indicating that the mobile device is waiting to receive data from the merchant server (e.g., an hourglass or a clock icon). Once the login form is sent to the merchant server, the mobile device waits for a response from the merchant server, and in step 516 the mobile device displays the initial app screen and any notices. In some embodiments, the initial app screen may include prompts to update user account information (e.g., credit card information, shipping addresses, preference data, third party social media sites, etc.). In other embodiments, the initial display screen may include a display of product matches (e.g., as a list of products with or without pictures, a scrollable display of product pictures, etc.). And, if the user is a seller, the initial display screen may include a seller dashboard with product and metric information as described above. Moreover, in some embodiments, the app display on the user's mobile device may include an indicator showing the number of new products matching the user's preferences. For example, if the merchant server determines that five new products match the user's preferences or the status of products saved to the user's favorite list have changed, the merchant server may send an update to the app indicating that there are new products or that a product is now unavailable. The display of any changed data can be included on the initial display or the app's display on the mobile device (e.g., a number on the icon for the app indicates the number of updates that have been made to the user's account). Once a connection has been established between the merchant server and the mobile device, the process ends in step 518.

Turning to FIG. 5D, the display module is initiated in step 520. In step 522, the display module may include instructions for updating or changing user information, including user preferences (e.g., adjust demographic information, keywords, preferences, billing and shipping data, and other information). In step 524, the module updates or transmits the customized product page or list to the user's mobile device. In some embodiments, where the user device has a product list uploaded as part of the program initiation (as discussed above), the display screen may include a prompt for refreshing the product list (e.g., to search for matching products that have been uploaded to the merchant server or database since the user's initial login). In other embodiments, the user may request a product list from the user initial screen. For example, the initial display screen may include selection menus or displays to choose to add contacts to the merchant server, change preference data, review comments, saved customized product pages, and/or to view matching product preferences—so the user would need to select viewing the matching product preferences for the product preferences to be uploaded to the mobile device. In other embodiments, the product list may be uploaded into the app periodically, at user request, and/or at program initiation. Returning to FIG. 5D, in step 526 the display module may prompt the user for credit card, shipping and billing information when the user selects the checkout prompt on the mobile device. As one skilled in the art will appreciate, the user's payment and shipping information may provided in response to prompt provided by the app, or may be in response to prompts provided to the mobile device by the merchant server. In step 528, the mobile device formats for display a payment receipt when the user's transaction is processed according to, for example, step 526 above. In some embodiments, the payment receipt display may include prompts to provide an email or text address so the receipt may be saved or kept for future viewing a payment confirmation. Finally, in step 530, the process ends.

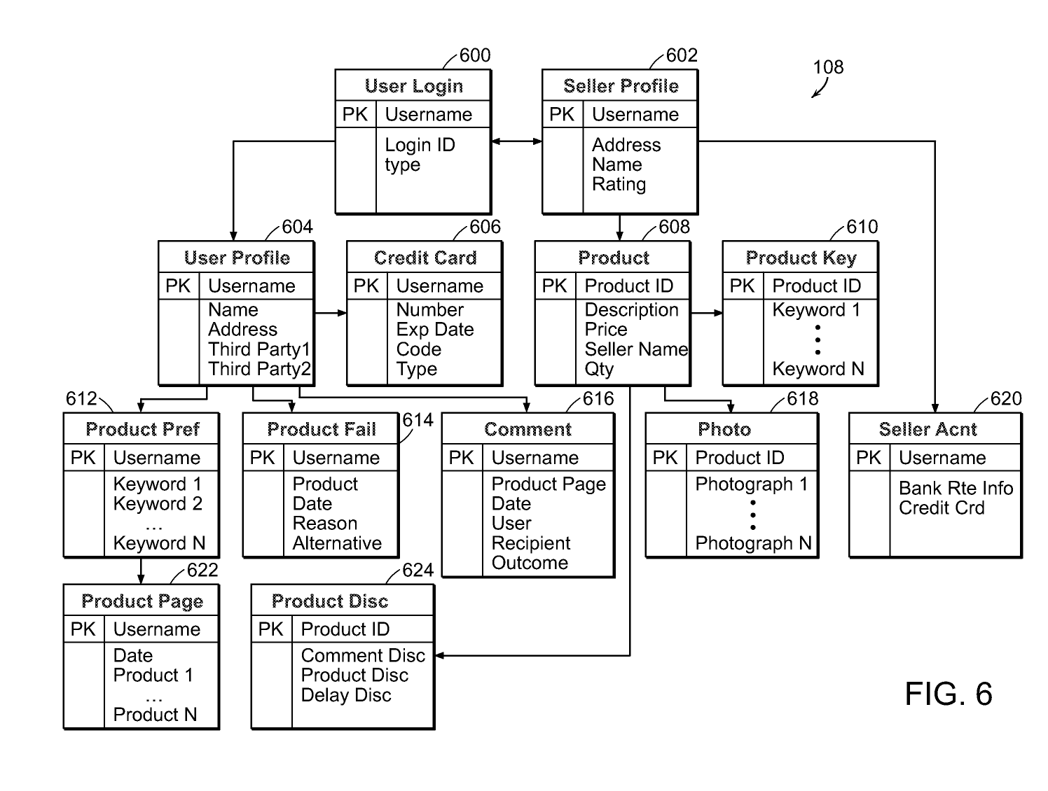

Turning to FIG. 6, an exemplary database 108 is organized into several tables for each of the steps described in FIGS. 4A-4G, including, for example, a user login table 600, a seller profile table 602, a user profile table 604, a credit card table 606, a product table 608, a product key table 610, a product preference table 612, a product fail table 614, a comment profile 616, a photo table 618, a seller account table 620, a product page table 622, and a product description table 624. In an exemplary embodiment, user login table 600 may include, a user name as a primary key, and login ID and user type a columns; the seller profile table 602 may include a username as a primary key, and the seller address, name and a seller rating, a rating of user's given to merchants using the site, as columns; a user profile table 604 that includes a username as a primary key and the user's name, address and third party social media profiles associated with the user as columns; a credit card table 606 may include a username as a primary key and the user's credit card number, expiration date, CVV code, and credit card type as columns; the product table 608 may include a product ID as a primary key and the product description, price, seller name and product quantity as columns; the product keyword table 610 may include the product ID as a primary key and one ore more keywords associated with the product as columns; the product preference table 612 may include a user name as the primary key and one ore more keywords associated with the user preferences as columns; the product fail table 614 may include the username as a primary key, and the product ID, date, reason and alternative product chosen; the comment table 616 may include the user name as a primary key, and the customized product page, date of comment, and indicator of whether the comment was posted by the user or recipient and the outcome of the conversation (e.g., did the user or recipient purchase the product); the photo table 618 that includes the product ID as a primary key and one or more photographs in columns, the seller account module 620 includes the username as the primary key and the bank routing information for the seller's bank account and credit card or other payment information for any services provided by the merchant server (e.g., ranking of products in the preference list, metrics, etc.); the product page table 622 includes the username as the primary key, the date of product purchase and the product's purchases as columns; and the product discount table 624 includes the product ID as the primary key and comment discount, product discount and display discount as separate columns.

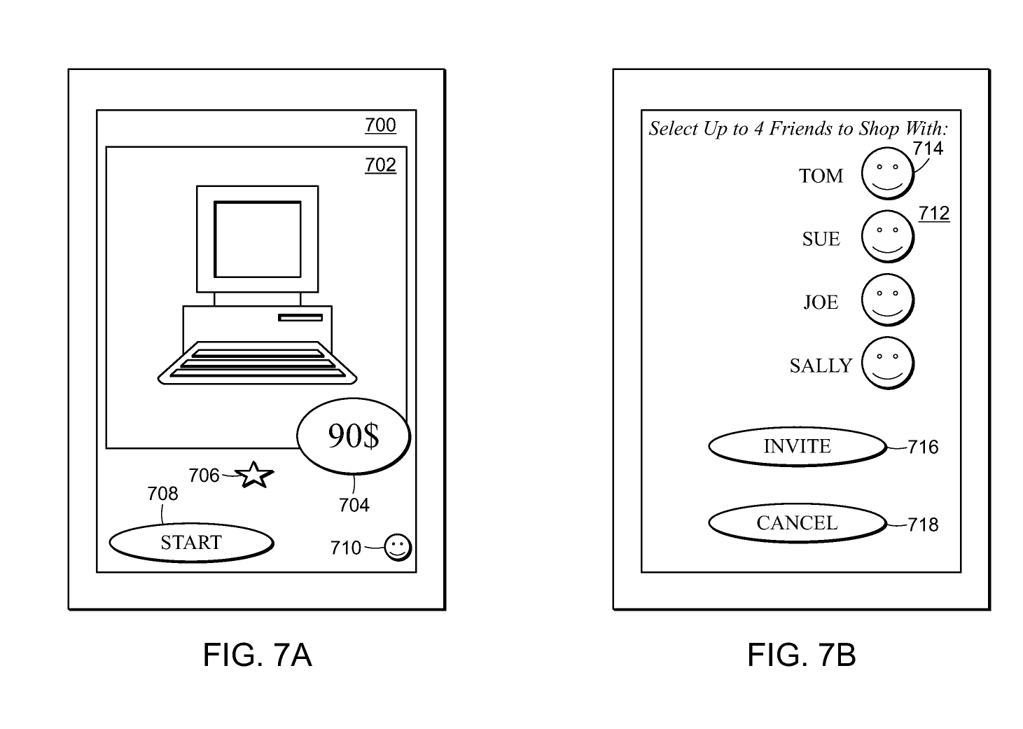

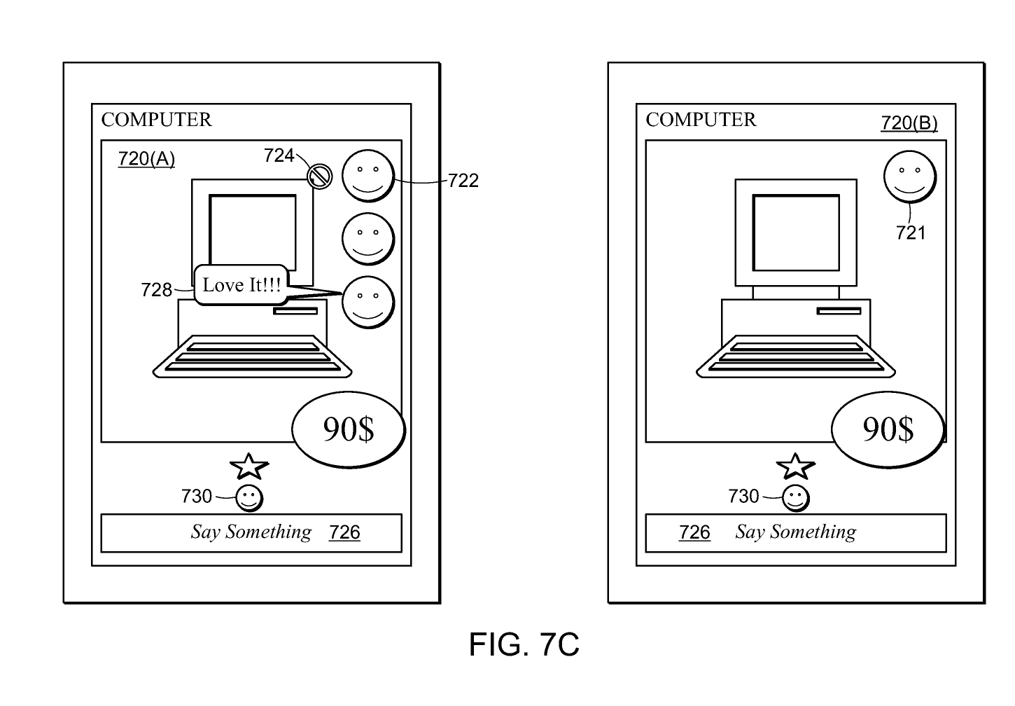

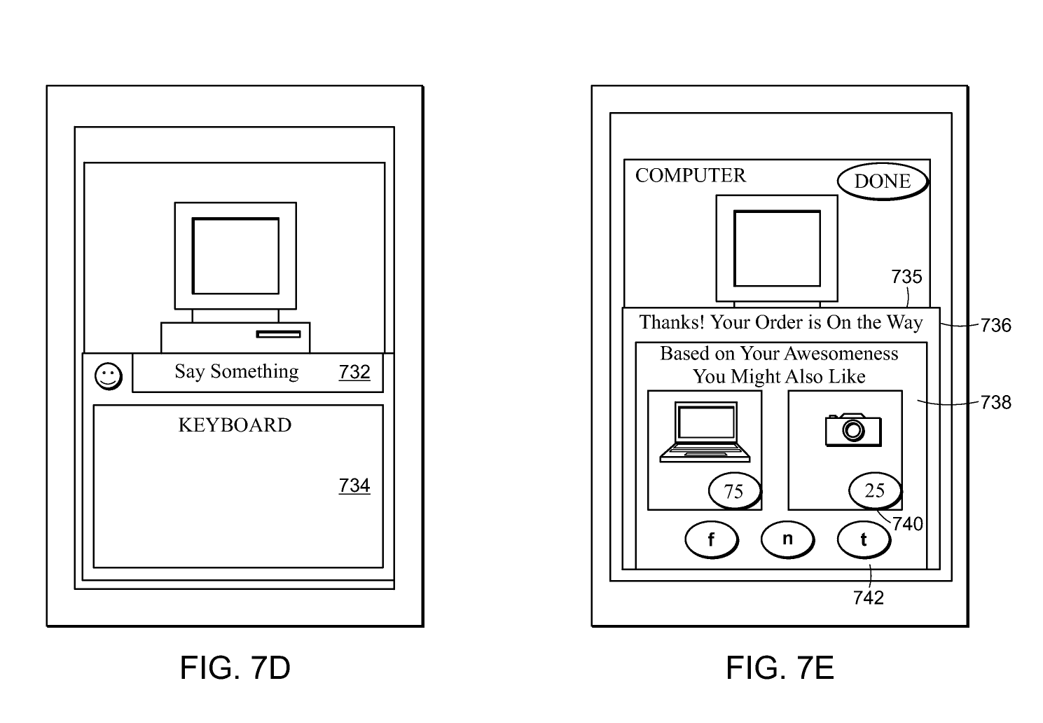

As one skilled in the art will appreciate, each of the relational tables may be used to construct GUIs as described for the program product above that allow a user to interact with the computer program of the instant invention, and exemplary GUIs and their functions will be described with reference to FIGS. 7A-7E.

FIG. 7A is an exemplary customized product page GUI 700 displaying an initial mobile device product screen 700, which may include one or more product pictures 702 presented in an automatically or manually scrolling display of pictures, product price 704, a favorite link 706 to like or save the product to a list of favorites for sharing, a start button 708 to initiate a shared display with one or more recipients to chat with one or more friends about a particular product or a plurality of products, and a symbolic link 710. The symbolic link 710 can include a menu of symbols such as faces that indicate emotions, check marks, no, hash mark or other negative symbols, etc., to post a symbolic comment to the customized product page for the product. In some embodiments, the product screen may also include a link that indicates that the product should not have been included in the product list so that the matching step of the merchant server described above can be refined for the user. Moreover, in some embodiments the customized product page can include links to recipients to communicate the product or product list to, for example, as an expandable list of names, photos, usernames, avatars or a combination thereof. In some embodiments, links to a text description for the product, a product quantity listing, an offer time such as how long until the offer of the product for sale expires, any warranties or other notices applicable to the product, the group or number of potential buyers the item has been offered to, etc. may also appear on the customized product page GUI 700. As one skilled in the art will recognize, the product listing may not be physical goods, but could also include service items. For example, a spa may post a picture with an offer for a massage, facial or other service; a mechanic may post a picture with an offer for an oil change, a drycleaner may post an offer for laundered clothing, etc. In this way, sellers for both goods and services may use the merchant server.

Turning to FIG. 7B, an exemplary select recipients GUI 712 is presented with a list of recipients that a user can link to when, for example, the user selects the start button 708 on the customized product page GUI 700. As discussed above, the select recipients GUI 712 may be an expandable list of recipients appearing on the customized product page GUI 700. The select recipients GUI 712 may include a list of potential recipients 714 of one or more user product links (e.g., a list of contacts exported from Gmail or a third party social media site). In some embodiments, the list of contact may be presented to the user with a username, name, photo, email address, avatar or any combination thereof. If the user wishes to share the one or more products, the user can select which contact(s) to share the product link (e.g., a click or tap of the contact can highlight the contact indicating it is selected). Once the intended recipients are selected, the user can click or tap the invite button 716 and the contacts will be sent a link to the product listing (e.g., as a Facebook® notification with a link, email, notification on the app installed on the recipient's mobile device, text message, etc.). If the user decides not to share the product list, the user can select the cancel button 718 to navigate back to the customized product page GUI 700. As one skilled in the art will recognize, the selection of the recipients does not need to be done when the application is first opened, but can be done anytime while the user is shopping (i.e., the list of recipients can be superimposed along the side of the screen and the user can invite the recipient at any time).

If the user selects one or more recipients to share a particular product with (or customized product page having a list of products), a user shared display GUI 720(a) will be presented to the user and a recipient shared display GUI 720(b) will be displayed to the recipient as shown in FIG. 7C. The user shared display GUI 720(a) includes, for example, a picture or symbol 722 representing the recipients the user shared the product (or customized product page) with, and any symbolic comments 724 that the user has sent to the user shared display (to be discussed below). The user-shared display GUI 720(a) may also include user text box 726 that would enable the user to share a comment regarding a particular product. For example, if the user likes a product he may include a comment to share with the recipients such as “do you think this is a good price?” In this way, the user may specify what type of feedback the user would like to receive from the recipients. The user shared display GUI 720(a) may also include a comment 728 (received from the recipient text box 726) and an symbolic link 730 enabling the user to post a symbolic comment next to the user's picture or symbol in the recipient shared display GUI 720(b). The recipient shared display GUI 720(b) is similar to the user shared display GUI 720(a), except that in some embodiments, the recipient shared display GUI 720(b) only includes the photo or symbol representing the user 721 (e.g., so the user can keep other contacts private). As one skilled in the art will recognize, however, in some embodiments the user shared display GUI 720(a) and recipient shared display GUI 720(b) may be identical (i.e., the shared display is presented to the user and all of the recipients for group chatting), or the user may select whether the recipient should receive a recipient shared display GUI 720(b) (i.e., a private display) or the user display GUI 720(a) (i.e., a common display). In some embodiments, the user can control the recipient shared display GUI 720(b) and scroll through products in the list on the recipient's device. In particular, as the user scrolls through products on his user's device, the same products will automatically show up on the recipient's device. Moreover, in some embodiments the user can pass control of the shared display GUI 720(a) and 720(b) off to one or more recipients. For example, the user may pass control of the shared display GUI 720(b) to a recipient to control other recipient shared display GUIs and the user shared display GUI. And, in some embodiments, when control is passed to the recipient, the recipient can purchase the item appearing in the shared display (either for the user or for the recipient).

Returning to FIG. 7D, if the user or recipient click or taps the text box 726, a text box display GUI 732 may be displayed to the user. As one skilled in the art will appreciate, the text box display GUI may include a keyboard 734 (for touch typing) or the display may include a large text box for the user or recipient to type a message using a keyboard associated with the user or recipient's mobile device or computer.

Finally, as shown in FIG. 7E, a checkout GUI 735 may be displayed to the user when the user decides to purchase a particular item. For example, the product price 704 appearing on the customized product page GUI 700 may be a button to checkout (e.g., clicking or tapping the price charges a user credit card account stored in the database for the user to be charged for the purchase). In some embodiments, however, clicking or tapping the price may link the user to a credit card charge form (not shown) that can be sent to the merchant server to process payment for the product. Once the transaction is complete, the merchant server transmits a confirmation display 736 to the user device, which may include a product suggestion display 738. For example, the product suggestion display 738 may include on or more items 740 that may be selected by the user, or may include the products from the customized product page that match the user's preferences. In this way, the merchant server can enable the user to continue shopping without reinitiating the app. Finally, the user can choose a third party social media site to share the purchase with by clicking third party links 742 (e.g., Facebook®, Pinterest®, and Twitter® links).

As one skilled in the art will further appreciate the display pages of FIGS. 7A-7E are exemplary of the GUIs that may be initiated by the computer program of the instant invention to perform the inventive functions herein (e.g., user account initiation GUIs, preference modification GUIs, shipping and payment GUIs, etc.). Other GUIs may be created that will help with efficiency of data entry, add additional features, or further enable the purchase of products using a mobile device, and accordingly not all embodiments of such GUIs have been described herein, but will be apparent to one of skill in the art. Accordingly, various GUIs may be used instead of or in addition to the GUIs described herein, and the GUIs are in no way to be considered limiting to the specification and claims, but are used for a descriptive sense only.

Moreover, in the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification, including the combination of the various embodiments described herein, and such modifications and changes are to be considered equivalents and part of this disclosure.

What is claimed is:

1. A computer for making products available for a user to purchase, the computer comprising:
a tangible non-transitory computer memory, the computer memory having stored thereon a plurality of computer instructions performing a process of creating a list of products that the user can purchase and a process of allowing the user to share a product from the list of products with a second user in real time, the instructions including the steps of:
creating the list of products using user tags, the user tags corresponding to user product preferences;
formatting a display page to display at least one product from the list of products on a mobile device associated with the user, the display page prompting the user to select a second user to share the display page with;
transmitting the display page to a second mobile device associated with the second user;
responsive to the transmission of the display page to the second user, formatting the display page to display the at least one product from the list of products on the second mobile device and allowing the user and second user to post comments regarding the product; and
allowing the user to control the display page on a second user mobile device to thereby enable the user and the second user to view substantially the same product on the display page.

2. The system of claim 1, wherein the user tags are determined from user postings on a social media profile page, the postings including at least one of user comments, likes, dislikes, relationship status, and educational institution, the instructions further including the steps of:
prompting the user for permission to link comments to their social media profile page;
linking the comments to the social media profile for display thereon; and
refining the list of products based on the comments.

3. The system of claim 1, wherein the display page includes at least two products appearing on in at least two different screen captures, the instructions further including the step of:
enabling the user to grant control of the display page to the second user so that the second user determine which of the at least two products the user and the second user should view at substantially the same time.

4. The system of claim 1, wherein the second user may be a plurality of second users, the instructions further including the step of:
enabling the user to selectively determine which of the plurality of second users can view the display page as substantially the same time as the user.

5. The system of claim 1, the instructions further including the steps of:
linking to one or more of a social media profile associated with the user, an email contact list associated with the user, or a mobile device contact list associated with the user to create a list of potential second users;
enabling the user to select one or more second users from the list of potential second users;
enabling the user to select whether the comments between the user an one of the second users can be viewed by the other second users selected.

6. The system of claim 1, further including the steps of:
storing product tags associated with each of a plurality of products available for purchase;
deriving user tags associated with the user based on at least one of user preferences identified by the user and a social media profile page associated with the user, the user tags including at least one of a user gender, a product type, a product manufacturer, and a product retailer;
creating the list of products by comparing the user tags to the product tags associated with each of the plurality of products available for purchase, selecting the list of products from the plurality of products available for purchase when the associated product tags match the user tags, and ranking the list of products by at least one of: relevance to the tags, price, date of product listing, product manufacturer, and product retailer; and
formatting the display page to display the at least one product from the list of products on the mobile device associated with the user.

7. The system of claim 5, the instructions further including the step of:
enabling the user to create the display page from products the user would like to sell;
enabling the user to select second users from the list of potential second users, and
responsive to the transmission of the display page to the second users, enabling each of the second users to purchase the products the user would like to sell.

8. A computer program product comprised of a series of instructions executable on a computer, the computer program product performing a process of creating a list of products that a user can purchase and a process of allowing the user to share a product from the list of products with a second user in real time, the computer program product further implementing the steps of:
creating the list of products using user tags, the user tags corresponding to user product preferences;
formatting a display page to display at least one product from the list of products on a mobile device associated with the user, the display page prompting the user to select a second user to share the display page with;
transmitting the display page to a second mobile device associated with the second user;
responsive to the transmission of the display page to the second user, formatting the display page to display the at least one product from the list of products on the second mobile device and allowing the user and second user to post comments regarding the product; and
allowing the user to control the display page on a second user mobile device to thereby enable the user and the second user to view substantially the same product on the display page.

9. The computer program product of claim 8, wherein the user tags are determined from user postings on a social media profile page, the postings including at least one of user comments, likes, dislikes, relationship status, and educational institution, and further implementing the steps of:
prompting the user for permission to link comments to their social media profile page;
linking the comments to the social media profile for display thereon; and
refining the list of products based on the comments.

10. The computer program product of claim 8, wherein the display page includes at least two products appearing on in at least two different screen captures, and further implementing the step of:
enabling the user to grant control of the display page to the second user so that the second user determine which of the at least two products the user and the second user should view at substantially the same time.

11. The computer program product of claim 8, wherein the second user may be a plurality of second users, and further implementing the step of:
enabling the user to selectively determine which of the plurality of second users can view the display page as substantially the same time as the user.

12. The computer program product of claim 8, further implementing the steps of:
linking to one or more of a social media profile associated with the user, an email contact list associated with the user, or a mobile device contact list associated with the user to create a list of potential second users;
enabling the user to select one or more second users from the list of potential second users;
enabling the user to select whether the comments between the user an one of the second users can be viewed by the other second users selected.

13. The computer program product of claim 8, further implementing the step of:
storing product tags associated with each of a plurality of products available for purchase;
deriving user tags associated with the user based on at least one of user preferences identified by the user and a social media profile page associated with the user, the user tags including at least one of a user gender, a product type, a product manufacturer, and a product retailer;
creating the list of products by comparing the user tags to the product tags associated with each of the plurality of products available for purchase, selecting the list of products from the plurality of products available for purchase when the associated product tags match the user tags, and ranking the list of products by at least one of: relevance to the tags, price, date of product listing, product manufacturer, and product retailer; and
formatting the display page to display the at least one product from the list of products on the mobile device associated with the user.

14. The computer program product of claim 12, further implementing the steps of:
enabling the user to create the display page from products the user would like to sell;
enabling the user to select second users from the list of potential second users, and
responsive to the transmission of the display page to the second users, enabling each of the second users to purchase the products the user would like to sell.

15. A computer-implemented method comprised of a series of instructions that cause a computer to perform a process of creating a list of products that the user can purchase and a process of allowing the user to share a product from the list of products with a second user in real time, the instructions including the steps of:
creating the list of products using user tags, the user tags corresponding to user product preferences;
formatting a display page to display at least one product from the list of products on a mobile device associated with the user, the display page prompting the user to select a second user to share the display page with;
transmitting the display page to a second mobile device associated with the second user;
responsive to the transmission of the display page to the second user, formatting the display page to display the at least one product from the list of products on the second mobile device and allowing the user and second user to post comments regarding the product; and
allowing the user to control the display page on a second user mobile device to thereby enable the user and the second user to view substantially the same product on the display page.

16. The computer-implemented method of claim 15, wherein the user tags are determined from user postings on a social media profile page, the postings including at least one of user comments, likes, dislikes, relationship status, and educational institution, the instructions further including the steps of:
prompting the user for permission to link comments to their social media profile page;
linking the comments to the social media profile for display thereon; and
refining the list of products based on the comments.

17. The computer-implemented method of claim 15, wherein the display page includes at least two products appearing on in at least two different screen captures, the instructions further including the step of:
enabling the user to grant control of the display page to the second user so that the second user determine which of the at least two products the user and the second user should view at substantially the same time.

18. The computer-implemented method of claim 15, the instructions further including the steps of:
linking to one or more of a social media profile associated with the user, an email contact list associated with the user, or a mobile device contact list associated with the user to create a list of potential second users;
enabling the user to select one or more second users from the list of potential second users;
enabling the user to select whether the comments between the user an one of the second users can be viewed by the other second users selected.

19. The computer-implemented method of claim 18, wherein the products are vintage products and further including the steps of:
enabling the second users to purchase the vintage products from the display page
enabling the user to select whether the comments between the user an one of the second users can be viewed by the other second users selected.
wherein the list of products is generated by searching the classification of products in the database and matching the classification to user tags.

20. The computer-implemented method of claim 18, the instructions further including the step of:
enabling the user to create the display page from products the user would like to sell;
enabling the user to select second users from the list of potential second users, and
responsive to the transmission of the display page to the second users, enabling each of the second users to purchase the products the user would like to sell.
